(19) United States
(12) Patent Application Publication
(10) Pub. No.: US 2025/0035182 A1
(43) Pub. Date: Jan. 30, 2025

(54) Torsional Vibration Damper

(71) Applicant: Hasse & Wrede GmbH, Berlin (DE)

(72) Inventors: Michael STEIDL, Berlin (DE); Stephan BOHMEYER, Hoppegarten (DE); Sebastian WILLEKE, Hoppegarten (DE)

(21) Appl. No.: 18/710,276

(22) PCT Filed: Nov. 15, 2022
(86) PCT No.: PCT/EP2022/081989

§ 371 Date: May 15, 2024

(30) Foreign Application Priority Data
Nov. 16, 2021 (DE) 10 2021 129 901.2

(51) Int. Cl. F16F 15/14; F16F 15/167

(52) U.S. Cl. CPC F16F 15/1435; F16F 15/167; F16F 2230/0005; F16F 2238/024

(57) ABSTRACT

A torsional vibration damper has a hub part, also referred to as primary mass, which can be fastened on a drive shaft of an engine, and an inertia ring, also referred to as secondary mass, which surrounds the hub part in the radially outer region. A damping device is provided between the hub part and the inertia ring. The torsional vibration damper includes an additional torsion spring, wherein the additional torsion spring is axially aligned.

### BACKGROUND AND SUMMARY

The present invention relates to a torsional vibration damper with a hub part—also referred to as a primary mass—which can be fastened on a drive shaft of an engine, and with an inertia ring—also referred to as a secondary mass—which surrounds the hub part in the radially outer region. A damping device is provided between the hub part and the inertia ring.

The damping device may, for example, be a visco-elastic fluid, such as silicone oil, which is accommodated in a chamber between the primary part and the secondary part, as is known, for example, from DE 10 2016 113 719 A1. It is also possible that the damping device comprises at least one elastomer element connected to the hub part and the inertia ring.

Such torsional vibration dampers, which are formed to dampen undesirable torsional vibrations, such as those that occur in combustion engines with reciprocating pistons, have proven very successful in practice. However, the disadvantage of such torsional vibration dampers is that they do not have sufficient torsion stiffness for the respective application, which means that the damper cannot be optimally formed for its application.

It has long been known from the state of the art to equip such torsional vibration dampers with additional torsion springs arranged radially to the axis of rotation, so that sufficient torsion stiffness of such a torsional vibration damper is provided. Torsional vibration dampers formed in this way can be found, for example, in DE 32 38 572 A1, DE 198 39 470 A1, DE 10 2009 004 252 A1 and EP 0 955 484 A1.

The disadvantage of these solutions is both the design and manufacturing complexity of such torsional springs arranged radially to the axis of rotation and the fact that the design of such a torsional vibration damper is not simplified by the torsional springs arranged radially to the axis of rotation.

The invention is therefore based on the problem of further developing a torsional vibration damper of the generic type in such a way that a more cost-effective design of the additional torsion spring and a simplified design of the torsion spring are possible.

This problem is solved by a torsional vibration damper with the features of the independent claims.

Accordingly, a torsional vibration damper is created with a hub part—also referred to as a primary mass—which can be attached on a drive shaft of an engine, and an inertia (damper) ring—also referred to as a secondary mass-which includes the hub part in the radially outer region, a damping device being provided between the hub part and the inertia ring. The torsional vibration damper comprises an additional torsion spring. The additional torsion spring is aligned essentially axially in relation to the torsional vibration damper.

That the additional torsion spring is essentially axially aligned in relation to the torsional vibration damper means that its spring effect is mainly based on torsion about an axial direction in relation to the axis of rotation of the torsional vibration damper. The torsion spring is thus preferably connected quasi-parallel to the damping device.

The at least one additional torsion spring is simple and compact to implement and can be adapted to a wide range of applications by means of simple design tests and, if necessary, calculations.

According to the invention, the damping device can also be, for example, a visco-elastic fluid, for example silicone oil, which is accommodated in a chamber between the primary part and the secondary part, for example as is known in this respect from DE 10 2016 113 719 A1. Alternatively, however, it is also possible for the damping device to be realized in another way, for example by an elastomer element.

In a particularly preferred embodiment of the invention, it is provided that the additional torsion spring is formed as a solid shaft or comprises such a shaft. This results in a torsion spring that is advantageously easy to deploy. This solid shaft is preferably aligned in the centre of the axis of rotation.

According to another particularly preferred embodiment, it is also provided that the additional torsion spring is formed as a hollow shaft or comprises such a shaft. This hollow shaft can in turn be aligned in the centre of the axis of rotation. This design also results in an additional torsion spring that is advantageously easy to form.

Furthermore, according to a further particularly preferred embodiment of the invention, it may be provided that the additional torsion spring comprises an arrangement of bar elements which are arranged circumferentially spaced apart from one another on a circle—a pitch circle—with the pitch circle being provided centred with respect to the axis of rotation. This results in a particularly space-saving arrangement of the additional torsion spring.

Combinations of the above-mentioned embodiments are also conceivable, e.g. a combination of two or more torsion springs, e.g. of two hollow shafts or a combination of a hollow shaft with a solid shaft, etc., Several of the torsion springs can also be provided.

It can be advantageous and structurally simple to provide that a first axial end of the axially extending torsion spring is directly or indirectly connected to the hub part or the inertia ring and another second axial end of the torsion spring is directly or indirectly connected to the inertia ring or the hub part.

It can also be advantageous and structurally simple for the torsion spring to be coupled to the hub part via a torsionally stiff disc or a torsionally stiff ring or a flange.

Furthermore, according to another particularly preferred embodiment of the invention, it is provided that the bar elements are located radially outwards in relation to the inertia ring or that they are located inwards in relation to the hub part in relation to a cylindrical section of this hub part.

In a further particularly preferred embodiment of the invention, it is provided that one axial end of the torsion spring is connected directly or indirectly to the hub part and another axial end of the additional torsion spring is connected directly or indirectly to the inertia ring. This results in a structurally simple solution for the mechanical coupling with the essential functional carriers of the torsional vibration damper when the additional torsion spring is arranged axially.

Preferably, a parallel connection of two springs is formed by the additional torsion spring in conjunction with the damping device. The parallel connection of the two springs results in a different spring rate for the torsional vibration damper, which advantageously simplifies the design of the torsional vibration damper.

According to a further particularly preferred embodiment of the invention, it is provided that the additional torsion spring is made of an elastic material.

Furthermore, according to a further particularly preferred embodiment of the invention, it may be provided that the damping device is formed as an elastomer which is vulcanized together with the hub part and the inertia ring in the manner of a rubber-metal part. This results in a mechanically robust damping device that is easy to manufacture.

Alternatively, according to a further particularly preferred embodiment of the invention, it is provided that the damping device is formed as a gap filled with a visco-elastic fluid between the hub part and the inertia ring. This results in a damping device that is essentially free from fluctuations in material parameters and thus operates precisely.

Further advantageous embodiments of the invention can be drawn from the dependent claims.

Some embodiments of the invention are described below with reference to the accompanying drawings. The invention is not limited to these embodiments. In particular, individual features of the following embodiments are applicable not only to these, but also to other embodiments.

### BRIEF DESCRIPTION OF THE DRAWINGS

FIG. 1 is a spatial sectional view of an embodiment of a torsional vibration damper according to the invention;

FIG. 2 is a spatial sectional view of an embodiment of a torsional vibration damper according to the invention;

FIG. 3 is a spatial sectional view of a further embodiment of a torsional vibration damper according to the invention;

FIG. 4 is a spatial sectional view of a further embodiment of a torsional vibration damper according to the invention;

FIGS. 5a and 5b are: (a) a diagram with a defined working area of an additional torsion spring in a torsional vibration damper according to FIG. 1, and (b) a diagram with a defined working area of an additional torsion spring in a torsional vibration damper according to FIG. 3,

In the following, terms such as “external” or “internal” refer to the respective drawing plane and “axial” and “radial” refer to the axis of rotation of the torsional vibration damper.

### DETAILED DESCRIPTION OF THE DRAWINGS

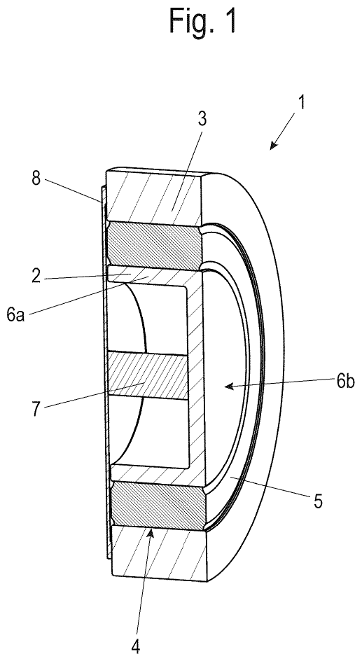

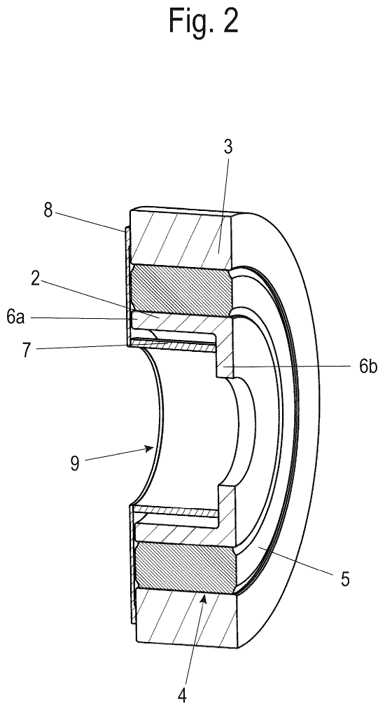

FIG. 1 shows a torsional vibration damper designated by the reference sign 1. The torsional vibration damper 1 comprises a hub part 2 which can be attached on a drive shaft of an engine, which can also be referred to as primary mass, and an inertia ring 3 which surrounds the hub part 2 in the radially outer region, which is also referred to as secondary mass. The hub part preferably comprises at least one cylindrical section 6a and at least one flange-like section 6b, which can be formed in the shape of a ring or disc (FIG. 2, FIG. 1). The flange can be formed at the end of the cylindrical section, but also elsewhere on such a section.

An annular gap 4 comprising a damping device 5 is preferably provided between the hub part 2 and the inertia ring 3. As shown in FIG. 1, the damping device 5 can be implemented as an elastomer which is vulcanized together with the hub part 2 and the inertia ring 3 in the manner of a rubber-metal part. The elastomer is preferably a high-temperature resistant elastomer, e.g. based on silicone rubber or fluorine rubber.

Alternatively, the damping device 5 can also be formed as a gap 4 filled with at least one visco-elastic fluid between the hub part 2 and the inertia ring 3, which may also be sealed additionally by sealing elements. The visco-elastic fluid is preferably silicone oil. A torsional vibration damper 1 with such a damping device 5 is known, for example, from DE 10 2016 113 719 A1. Other embodiments of damping device are also conceivable.

The hub part 2 can—see FIG. 1—be provided with the aforementioned flange 6b, on which circumferentially distributed holes can be located on a pitch circle (not shown here), which are used for attachment of the torsional vibration damper 1, e.g. to a crankshaft of a combustion engine. The flange 6b may also comprise a concentric aperture.

In the embodiment of the torsional vibration damper in FIG. 1, an additional torsion spring 7 made of an elastic material is attached to the hub part 2, in particular to the axial inside of the flange 6b (in relation to the torsional vibration damper 1) in axial alignment. This is located on the inside of the cylindrical section 6a. The additional torsion spring 7 extends in an axial direction in relation to the axis of rotation of the torsional vibration damper 1.

The material of the additional torsion spring 7 can be a material with essentially linear tension-strain characteristic, such as metals. However, it can also be a material with progressive or degressive tension-strain characteristic.

The additional torsion spring 7 is formed here as a solid shaft and is mechanically coupled to the inertia ring 3. This coupling is effected here by a torsionally stiff disc 8 coupling the hub part 2 and the inertia ring 3. For this purpose, the additional torsion spring 7 is attached to the torsionally stiff disc 8. The torsionally stiff disc 8 can also comprise a concentric aperture 9, so that the torsionally stiff disc 8 is then embodied as a ring.

The torsionally stiff disc 8 is attached axially to the outside of the inertia ring 3. The torsionally stiff disc 8 comprises a smaller outer diameter than the inertia ring 3 and is embodied here without the aperture 9, so that the additional torsion spring 7, which is arranged concentrically to the axis of rotation of the torsional vibration damper 1 and formed here as a solid shaft, can be easily attached to the torsionally stiff disc 8.

In this way, one end of the additional torsion spring 7 is connected to the hub part 2 via the flange 6b and another end of the additional torsion spring 7 is connected to the inertia ring 3 via the torsionally stiff disc 8.

The additional torsion spring 7 arranged in this way creates a parallel connection of two torsion springs in conjunction with the damping device 5. The parallel connection of the two torsion springs results in a different operating characteristic for the torsional vibration damper 1.

The design of the additional torsion spring 7 as a solid shaft results in a simple geometry of the additional torsion spring 7, so that the additional torsion spring 7 can be easily provided.

FIG. 2 shows an embodiment of the torsional vibration damper 1. In the torsional vibration damper 1 according to FIG. 2, the additional torsion spring 7 is embodied as a hollow shaft or sleeve, in contrast to the torsional vibration damper according to FIG. 1. The additional torsion spring 7 is attached on the flange 6b and extends in an axial direction in relation to the axis of rotation of the torsional vibration damper 1 and is mechanically coupled to the inertia ring 3. The sleeve is again on the inside of the cylindrical section 6a.

This coupling is effected here by a torsionally stiff disc 8 coupling the hub part 2 and the inertia ring 3. For this purpose, the additional torsion spring 7 is attached to the torsionally stiff disc 8.

In this way, one end of the additional torsion spring 7 is connected to the hub part 2 via the flange 6b and another end of the additional torsion spring 7 is connected to the inertia ring 3 via the torsionally stiff disc 8.

The torsionally stiff disc 8 is attached to the inertia ring 3 axially on the outside, here opposite the flange 6b of the hub part 2. The torsionally stiff disc 8 comprises a smaller outer diameter than the inertia ring 3 and is implemented here with the aperture 9, so that the additional torsion spring 7, which is arranged concentrically to the axis of rotation of the torsional vibration damper 1 and formed here as a hollow shaft, can be easily attached to the torsionally stiff disc 8. This results in a space-saving arrangement of the additional torsion spring 7.

The additional torsion spring 7 is made of an elastic material. The material can be a material with essentially linear tension-strain characteristic, such as metals. However, it can also be a material with progressive or degressive tension-strain characteristic.

The additional torsion spring 7 arranged in this way creates a parallel connection of two torsion springs in conjunction with the damping device 5. The parallel connection of the two torsion springs results in a total torsion spring rate for the torsional vibration damper 1 that is higher than the torsion spring rate of the damping device 5 alone.

The design of the additional torsion spring 7 as a hollow shaft results in a simple geometry of the additional torsion spring 7, so that the additional torsion spring 7 can be easily formed.

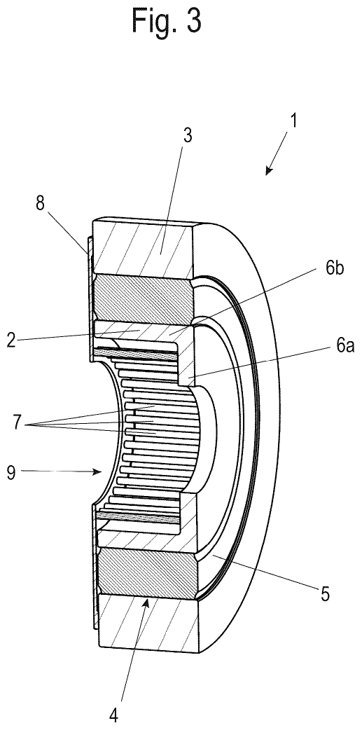

FIG. 3 shows a further embodiment of the torsional vibration damper 1. In the torsional vibration damper 1 shown in FIG. 3, in contrast to the torsional vibration damper shown in FIG. 1, the additional torsion spring 7 is implemented by an arrangement of bar elements that are subjected to bending (main load), tension, compression and torsion.

The bar elements, which are arranged here spaced apart from one another on a pitch circle with uniform pitch, are attached to the flange 6b radially inwards in relation to the hub part 2 and extend in an axial direction in relation to the axis of rotation of the torsional vibration damper 1.

The additional torsion spring 7 is, meanwhile, mechanically coupled to the inertia ring 3. In this case, this coupling is provided by a torsionally stiff disc 8 that couples the hub part 2 and the inertia ring 3. For this purpose, the torsionally stiff disc 8 is attached to the inertia ring 3 axially on the outside, in this case opposite the flange 6b of the hub part 2, and the additional torsion spring 7 is attached to the torsionally stiff disc 8.

The torsionally stiff disc 8 comprises a smaller outer diameter than the inertia ring 3 and is implemented here with the aperture 9, so that the additional torsion spring 7, which is arranged concentrically to the axis of rotation of the torsional vibration damper 1 and implemented here as an arrangement of bar elements, can be easily attached to the torsionally stiff disc 8. This results in a space-saving arrangement of the additional torsion spring 7.

The respective bar element of the additional torsion spring 7 is attached to the flange 6b and to the torsionally stiff disc 8, preferably by means of fixed clamping. However, it can also be attached on one or both sides by means other than a fixed clamping.

In this way, one end of the additional torsion spring 7 is connected to the hub part 2 via the flange 6b and another end of the additional torsion spring 7 is connected to the inertia ring 3 via the torsionally stiff disc 8.

The additional torsion spring 7—in this case hence each individual bar element—is made of an elastic material. The material can be a material with essentially linear tension-strain characteristic, such as metals. However, it can also be a material with progressive or degressive tension-strain characteristic.

The additional torsion spring 7 arranged in this way creates a parallel connection of two torsion springs in conjunction with the damping device 5. The parallel connection of the two torsion springs results in a total torsion spring rate for the torsional vibration damper 1 that is higher than the torsion spring rate of the damping device 5 alone.

The design of the additional torsion spring 7 as an arrangement of bar elements results in a simple geometry of the additional torsion spring 7, so that the additional torsion spring 7 can be easily implemented.

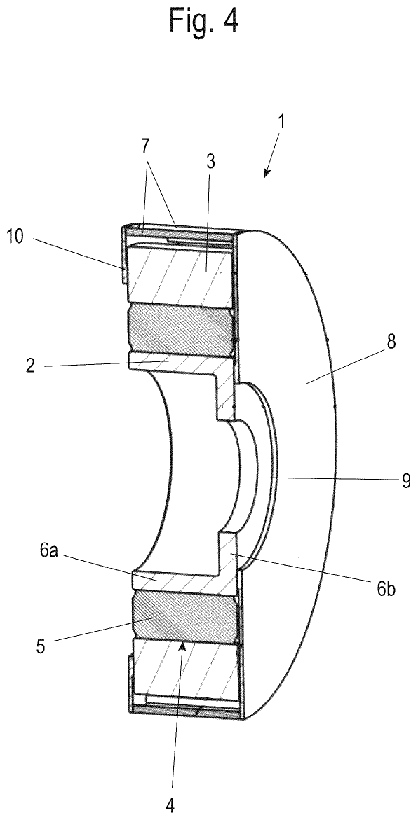

FIG. 4 shows another embodiment of the torsional vibration damper 1. In the torsional vibration damper 1 shown in FIG. 4, in contrast to the torsional vibration damper shown in FIG. 1, the additional torsion spring 7 is realized by an arrangement of bar elements that are subjected to bending (main load), tension, compression and torsion.

The bar elements, which are arranged here spaced apart from one another on a pitch circle with an even pitch, are attached radially on the outside to a ring 10 in relation to the inertia ring 3 and extend in an axial direction in relation to the axis of rotation of the torsional vibration damper 1.

The ring 10 is attached to the inertia ring 3 axially on the outside, here opposite the flange 6b of the hub part 2. The ring 8 comprises a larger outer diameter than the inertia ring 3, so that the additional torsion spring 7, which is arranged concentrically to the axis of rotation of the torsional vibration damper 1 and formed here as an arrangement of bar elements, can be easily attached to the ring.

The additional torsion spring 7 is mechanically coupled to the hub part 2 by a torsionally stiff disc 8. This coupling is effected here by a torsionally stiff disc 8 coupling the hub part 2 and the inertia ring 3. For this purpose, the torsionally stiff disc 8 is axially attached to the hub part 2 and the additional torsion spring 7 is attached to the torsionally stiff disc 8. The torsionally stiff disc 8 comprises the concentric aperture 9 and is accordingly implemented here as a ring.

The torsionally stiff disc 8 is attached to the inertia ring 3 axially on the outside, here on the side of the flange 6b of the hub part 2. The torsionally stiff disc 8 comprises a larger outer diameter than the inertia ring 3 and is implemented here with the aperture 9, so that the additional torsion spring 7, which is arranged concentrically to the axis of rotation of the torsional vibration damper 1 and formed here as an arrangement of bar elements, can be easily attached to the torsionally stiff disc 8.

The respective bar element of the additional torsion spring 7 is attached to the ring 10 and to the torsionally stiff disc 8, preferably by means of a fixed clamp. However, it can also be attached on one or both sides by means other than a fixed clamp.

In this way, one end of the additional torsion spring 7 is connected to the hub part 2 via the torsionally stiff disc 8 and the other end of the additional torsion spring 7 is connected to the inertia ring 3 via the ring 10.

The additional torsion spring 7 is made of an elastic material. The material can be a material with essentially linear tension-strain characteristic, such as metals. However, it can also be a material with progressive or degressive tension-strain characteristic.

The additional torsion spring 7 arranged in this way creates a parallel connection of two torsion springs in conjunction with the damping device 5. The parallel connection of the two torsion springs results in a total torsion spring rate for the torsional vibration damper 1 that is higher than the torsion spring rate of the damping device 5 alone.

The design of the additional torsion spring 7 as an arrangement of bar elements results in a simple geometry of the additional torsion spring 7, so that the additional torsion spring 7 can be easily formed.

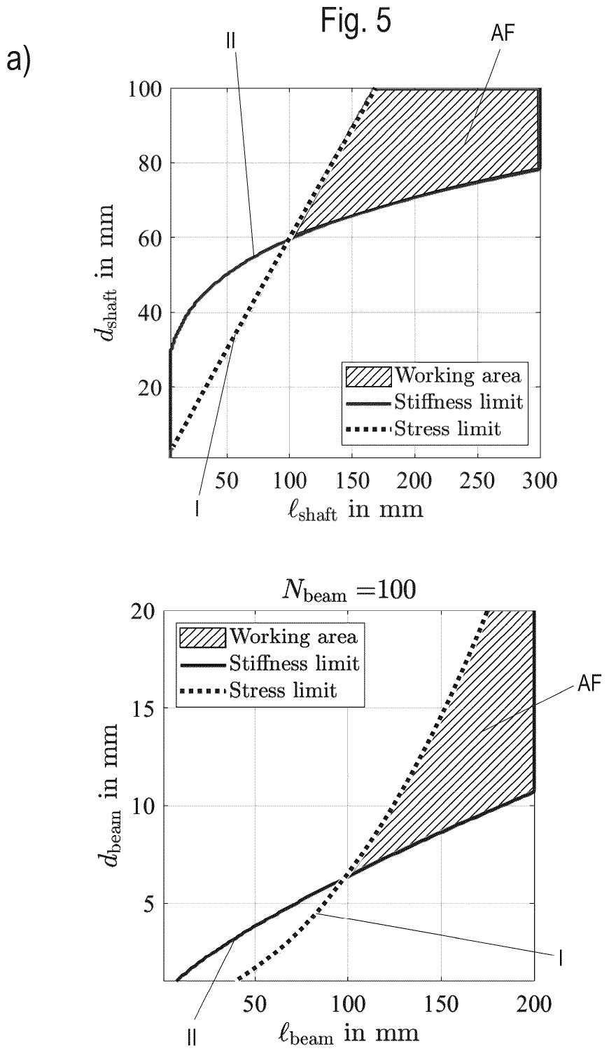

FIG. 5a shows an implementation diagram of the additional torsion spring 7 according to FIG. 1. The additional torsion spring 7 in the embodiment shown in FIG. 1 is provided as a solid shaft.

The length 1 of the additional torsion spring 7, which is formed here as a solid shaft, is plotted on the X-axis of the embodiment diagram. The diameter d of the additional torsion spring 7, which is formed here as a solid shaft, is plotted on the Y-axis.

A graph I characterizes the maximum bearable mechanical tension with elastic deformation—i.e. the resistance to plastic deformation—of the fully cylindrical additional torsion spring 7, while a graph II characterizes the minimum stiffness—i.e. the resistance to elastic deformation—of the fully cylindrical additional torsion spring 7. A permissible working area AF of the additional torsion spring 7 according to FIG. 1 lies above graph II and below graph I.

FIG. 5b shows an implementation diagram of the additional torsion spring 7 according to FIG. 3. The additional torsion spring 7 in the embodiment according to FIG. 1 is formed as an arrangement of bar elements. The number of bar elements forming the additional torsion spring 7 is specified here as n=100.

The length 1 of the respective bar element of the additional torsion spring 7 is plotted on the X-axis of the embodiment diagram. The diameter d of the respective bar element of the additional torsion spring 7 is plotted on the Y-axis.

A graph I characterizes the maximum bearable mechanical tension—i.e. the resistance to elastic deformation—of the respective bar element of the fully cylindrical additional torsion spring 7, while a graph II characterizes the minimum stiffness—i.e. the resistance to elastic deformation—of the respective bar element of the fully cylindrical additional torsion spring 7. A permissible working area AF of the additional torsion spring 7 according to FIG. 3 lies above graph II and below graph I.

REFERENCE LIST

| | |
|---|---|
| Torsional vibration dampers | 1 |
| Hub part | 2 |
| Inertia (damper) ring | 3 |
| Gap | 4 |
| Damping element | 5 |
| Cylindrical section | 6a |
| Flange | 6b |
| Additional torsion spring | 7 |
| Torsionally stiff disc | 8 |
| Aperture | 9 |
| Ring | 10 |
| I | Graph |
| II | Graph |
| AF | Work area |

1.-14. (canceled)

15. A torsional vibration damper, comprising:
a hub part as a primary mass, which hub part is fastenable on a drive shaft of an engine;
an inertia ring as a secondary mass, which inertia ring surrounds the hub part in a radially outer region;
a damping device provided between the hub part and the inertia ring, wherein
the torsional vibration damper comprises an axis of rotation, and
wherein a torsion spring is provided in addition to the damping device and couples the hub part and the inertia ring, wherein the torsion spring is substantially axially aligned.

16. The torsional vibration damper according to claim 15, wherein
the torsion spring comprises a solid shaft which is aligned centrally to the axis of rotation.

17. The torsional vibration damper according to claim 15, wherein
the torsion spring comprises a hollow shaft which is aligned centrally to the axis of rotation.

18. The torsional vibration damper according to claim 15, wherein
the torsion spring comprises an arrangement of bar elements, which bar elements are arranged spaced apart from one another on a pitch circle, the pitch circle being aligned centrally to the axis of rotation.

19. The torsional vibration damper according to claim 15, wherein
a first axial end of the torsion spring is connected directly or indirectly to the hub part and a second axial end of the torsion spring is connected directly or indirectly to the inertia ring.

20. The torsional vibration damper according to claim 15, wherein
the torsion spring is coupled to the hub part in each case via a torsionally stiff disc or a torsionally stiff ring or a flange.

21. The torsional vibration damper according to claim 15, wherein
the torsion spring is coupled to the inertia ring in each case via a torsionally stiff disc or a torsionally stiff ring or a flange.

22. The torsional vibration damper according to claim 18, wherein
the bar elements are located radially inwards in relation to the hub part.

23. The torsional vibration damper according to claim 18, wherein
the bar elements are located radially on an outer side in relation to the hub part and the inertia ring.

24. The torsional vibration damper according to claim 20, wherein
a respective bar element is attached to the flange and to the torsionally stiff disc, or to the ring and to the torsionally stiff disc.

25. The torsional vibration damper according to claim 15, wherein
a parallel connection of two springs is formed by the additional torsion spring in interaction with the damping device.

26. The torsional vibration damper according to claim 15, wherein
the additional torsion spring is made of an elastic material.

27. The torsional vibration damper according to claim 15, wherein
the damping device is formed as an elastomer which is vulcanized so as to form a rubber-metal part together with the hub part and the inertia ring.

28. The torsional vibration damper according to claim 15, wherein
the damping device is formed as a gap filled with a visco-elastic fluid between the hub part and the inertia ring.
